(19) United States
(12) Patent Application Publication
(10) Pub. No.: US 2025/0281782 A1
(43) Pub. Date: Sep. 11, 2025

(54) BULLDOZERS

(71) Applicant: Grant Stanton Cooper, San Rafael, CA (US)

(72) Inventor: Grant Stanton Cooper, San Rafael, CA (US)

(21) Appl. No.: 19/219,065

(22) Filed: May 27, 2025

Related U.S. Application Data
(63) Continuation-in-part of application No. 17/859,492, filed on Jul. 7, 2022, now Pat. No. 12,329,999.
(60) Provisional application No. 63/219,635, filed on Jul. 8, 2021.

(51) Int. Cl. A62C 27/00; A62C 3/02

(52) U.S. Cl. CPC A62C 27/00; A62C 3/0278; A62C 3/0292

(57) ABSTRACT

An apparatus for a bulldozer that makes the process of controlling wildfires safer and more effective. The apparatus includes a large capacity water tank that can be mounted to the rear of the bulldozer using a frame. A pump can draw water from the water tank and pump the water at a very high pressure. One or more hose reels can also be provided. Strategically positioned sprinklers can spray water over the nearby surroundings, such as the Fireline made by the dozer.

### CROSS-REFERENCE TO RELATED APPLICATIONS

This application is a continuation-in-part of a Ser. No. 17/859,492 filed on Jul. 7, 2022, which claims priority from a U.S. Provisional Patent Appl. No. 63/219,635 filed on Jul. 8, 2021, both of which are incorporated herein by reference in their entirety.

### FIELD OF INVENTION

The present invention relates to a fire dozer (bulldozer), and more particularly, the present invention relates to an apparatus for a fire dozer that aids in controlling the fire and protects the dozer from fire.

### BACKGROUND

Wildfires, also referred to as forest fires, are a severe natural disaster that cause extensive damage to landscapes, ecosystems, human life, and property. In addition to the immediate destruction caused by uncontrolled and large-scale wildfires, the release of greenhouse gases significantly contributes to climate change and global warming. While wildfires do not typically ignite and spread instantaneously, they often progress over extended periods-days, weeks, or even months. This prolonged development presents an opportunity to intervene and limit the spread of the fire, thereby mitigating further harm to the environment, infrastructure, and human life.

Combatting wildfires presents numerous challenges due to the vast scale of the fires, the presence of natural and man-made obstacles, and the rugged, often inaccessible terrain. Traditional firetrucks are frequently unable to access these remote or hazardous areas. In response, fire dozers have gained popularity as an alternative means of wildfire control. These machines are capable of traversing difficult terrain and are used to create firebreaks-cleared paths that help contain the spread of fire. However, conventional fire dozers are not specifically designed or fully equipped for active firefighting and therefore suffer from several critical limitations. These shortcomings have contributed to operational inefficiencies and, in some cases, have led to accidents and safety hazards for personnel.

Accordingly, there exists a recognized need for improved fire dozer systems and apparatuses that address the limitations of current models. There is a particular need for enhancements that increase the safety and effectiveness of wildfire suppression efforts, especially in challenging terrains where conventional firefighting equipment cannot operate effectively.

It is to be noted that the terms “fire dozer” and “bulldozer” are interchangeably used herein after, and refers to a bulldozer for dozing the fires.

### SUMMARY OF THE INVENTION

The following presents a simplified summary of one or more embodiments of the present invention to provide a basic understanding of such embodiments. This summary is not an extensive overview of all contemplated embodiments and is intended to neither identify critical elements of all embodiments nor delineate the scope of any or all embodiments. Its sole purpose is to present some concepts of one or more embodiments in a simplified form as a prelude to the more detailed description that is presented later.

The principal object of the present invention is therefore directed to an apparatus for a fire dozer that can make firefighting more effective and safer.

It is another object of the present invention that the apparatus can retrofit to a fire dozer.

It is still another object of the present invention that the apparatus can be installed in new fire dozers.

It is a further object of the present invention that the apparatus can safeguard the operator and dozer from fire.

It is yet another object of the present invention that the apparatus does not significantly affect the operation and stability of the fire dozer.

In one aspect, an apparatus for a fire dozer is disclosed that are safer and more effective in controlling wildfires. Also, disclosed is a fire dozer for dozing the fire.

### BRIEF DESCRIPTION OF THE DRAWINGS

The accompanying figures, which are incorporated herein, form part of the specification and illustrate embodiments of the present invention. Together with the description, the figures further explain the principles of the present invention and to enable a person skilled in the relevant arts to make and use the invention.

FIG. 1 is a side view of a fire dozer and an apparatus, according to an exemplary embodiment of the present invention.

FIG. 2 is a top view of the fire dozer, according to an exemplary embodiment of the present invention.

FIG. 3 shows the pumps, and the cabinets swiveled outwards, according to an exemplary embodiment of the present invention.

### DETAILED DESCRIPTION

Subject matter will now be described more fully hereinafter. Subject matter may, however, be embodied in a variety of different forms and, therefore, covered or claimed subject matter is intended to be construed as not being limited to any exemplary embodiments set forth herein; exemplary embodiments are provided merely to be illustrative. Likewise, a reasonably broad scope for claimed or covered subject matter is intended. Among other things, for example, the subject matter may be embodied as apparatus and methods of use thereof. The following detailed description is, therefore, not intended to be taken in a limiting sense.

The word “exemplary” is used herein to mean “serving as an example, instance, or illustration.” Any embodiment described herein as “exemplary” is not necessarily to be construed as preferred or advantageous over other embodiments. Likewise, the term “embodiments of the present invention” does not require that all embodiments of the invention include the discussed feature, advantage, or mode of operation.

The terminology used herein is for the purpose of describing particular embodiments only and is not intended to be limiting of embodiments of the invention. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The following detailed description includes the best currently contemplated mode or modes of carrying out exemplary embodiments of the invention. The description is not to be taken in a limiting sense but is made merely for the purpose of illustrating the general principles of the invention, since the scope of the invention will be best defined by the allowed claims of any resulting patent.

The following detailed description is described with reference to the drawings, wherein like reference numerals are used to refer to like elements throughout. In the following description, for purposes of explanation, specific details may be set forth in order to provide a thorough understanding of the subject innovation. It may be evident, however, that the claimed subject matter may be practiced without these specific details. In other instances, well-known structures and apparatus are shown in block diagram form in order to facilitate describing the subject innovation. Moreover, the drawings may not be to scale.

### REFERENCE NUMERALS

1 Pump
1a Steel Platform
1b Platform hinge
2 Hose reels
2a Valves
3 Hose reel platforms
3a Platform hinge
4 Remote Control Fire Monitor
4a Exhaust stack
5 Fire Hose Storage on the back of the dozer blade
6 Fire Hose Storage on the back of the canopy
8 Tank
8a Filling hole
8b Drain hole
8c Fire Hose filling ports
9 Heavy Angle Iron Protective Frame
10 Heavy channel iron on the sides of the tank
11 Bolt on Brackets on the tank to the dozer
12 Manifold
12a Outlet 1:1.5 inches male hose connection with Valve
12b Outlet 2:1 inch male hose connection with Valve
12c Side Spray with Valve
13 Protective Hose Reel Steel Cabinets
14 Protective Fire pump steel cabinet
15 Storage cabinets
100 Hitch
102 Tank
104 Tank
106 Tank
108 Tank
110 Tank

The present invention relates to an apparatus for a fire dozer that enhances both the safety and effectiveness of wildfire suppression operations. Also disclosed are fire dozers equipped with the proposed apparatus. The fire dozer retains all functional advantages of a conventional crawler-type tractor, including bush clearing and bulldozing capabilities. The apparatus further enables the use of water or similar fire retardants to suppress active fire and to protect the fire dozer from heat and flame exposure.

The apparatus is designed to securely support a large-capacity water tank in a stable manner, minimizing wobbling and ensuring safe and efficient operation over rugged and uneven terrain. The disclosed fire dozer can actively extinguish fire advancing toward the fireline, thereby mitigating risks to both the equipment and the operator. By suppressing flames at the containment boundary, the apparatus plays a critical role in preventing the fire from breaching containment lines, which is essential for limiting the size and duration of the wildfire.

In addition, the disclosed apparatus integrates functionalities typically associated with fire trucks, including the accommodation of large water tanks, high-capacity water pumps, hose reels, hose manifolds, fire monitors, and side spray systems. The system may also be adapted to apply chemical fire retardants commonly used in wildfire management, further expanding its firefighting capabilities.

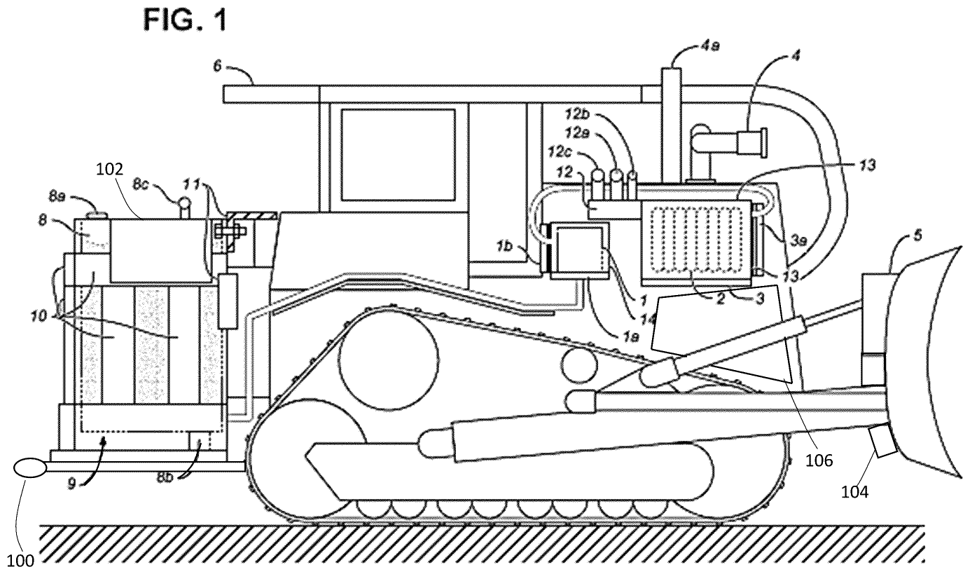

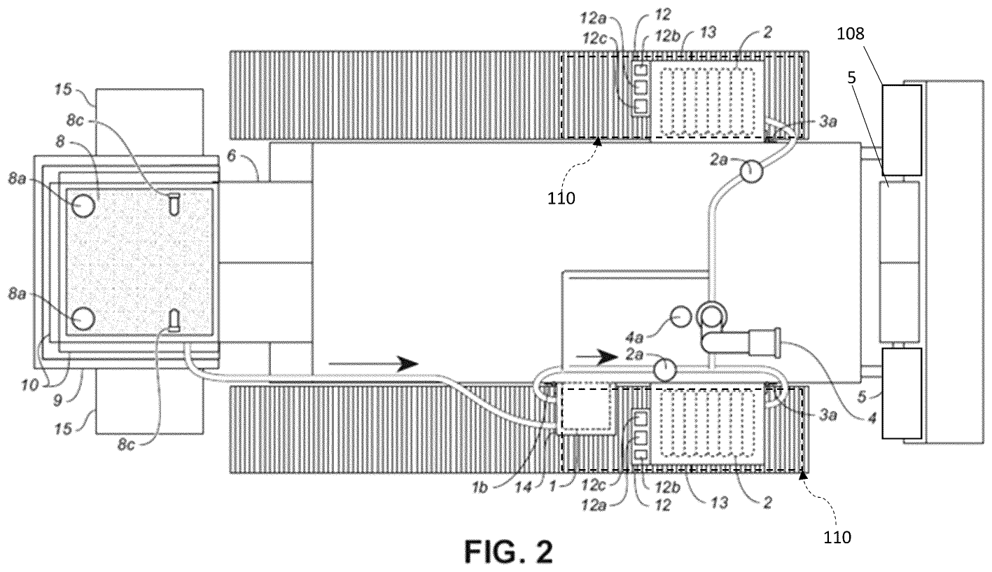

Referring to FIGS. 1 and 2, the apparatus can include a pump 1. The pump can be a high-pressure pump suitable for firefighting and can be installed in front or side of an operator cabin door. The pump's input can be connected to a water tank 8 through a suitable conduit. In one implementation, the pumps can deliver at least 200 PSI to pump water uphill to a fire that is several hundred feet higher than the dozer. The pumps can be mounted on a custom-built hinged steel platform 1a that will allow the pump to swing away, providing access to the dozer's internal hardware for maintenance when needed. The hinge 1b can be used to mount the pump. The pumps can be covered by a steel cover attached to the swing platform, protecting the pump from tree or brush damage.

The water tank can be mounted on the rear of the dozer. FIGS. 1 and 2 show a large capacity tank mounted to the rear end of the dozer using a bolt-on bracket on the tank to the chassis of the dozer 11. It is understood, however, that any other brackets and supports can be used to mount the tank, depending on the weight of the tank, and any such brackets and supports are within the scope of the present invention. FIG. 1 shows the heavy angle iron protective frame 9 and heavy channel iron bars on the sides of tank 10 for support and protection of the tank from external impacts and insults. Any suitable protective frame can be used to protect the tank and shield it from external impacts. On top of the tank, there can be a filling hole 8a for filling water into the tank. At the bottom of the tank, there can be a drain hole 8b for emptying the tank. The size of the tank can be important to hold enough water to be usable for extinguishing any fire reaching the Fireline. At the same time, the size must also not exceed to an extent that disrupts the balance and stability of the dozer. The size of the tank can depend on the size of the dozer. The tank can be made from a heavy steel plate. Suitable numbers of baffles can be provided inside the tank to reduce water movement, preventing any wobble that may destabilize the dozer. The tank can be made from water-resistant material. Alternatively, a coating can be provided, at least on the inner surface of the tank, to prevent corrosion, such as a rust preventive coating. The conduit connecting to the bottom of the tank can also be galvanized to keep corrosion to a minimum.

Connected to the pump can be a custom-built water pipe assembly that can be custom fitted for each dozer to deliver water to one or more hose reels 2 mounted on one or more locations on the dozer, but typically on the sides of the dozer. The hose reels can typically carry at least 100 feet of hardline hose with a hose nozzle appended that fire personnel can use to put out fires. FIG. 2 shows two hose reels on the left and right sides of the dozer present at the engine compartment doors. Valve 2a can be used to turn on and off the water supply to different hose reels.

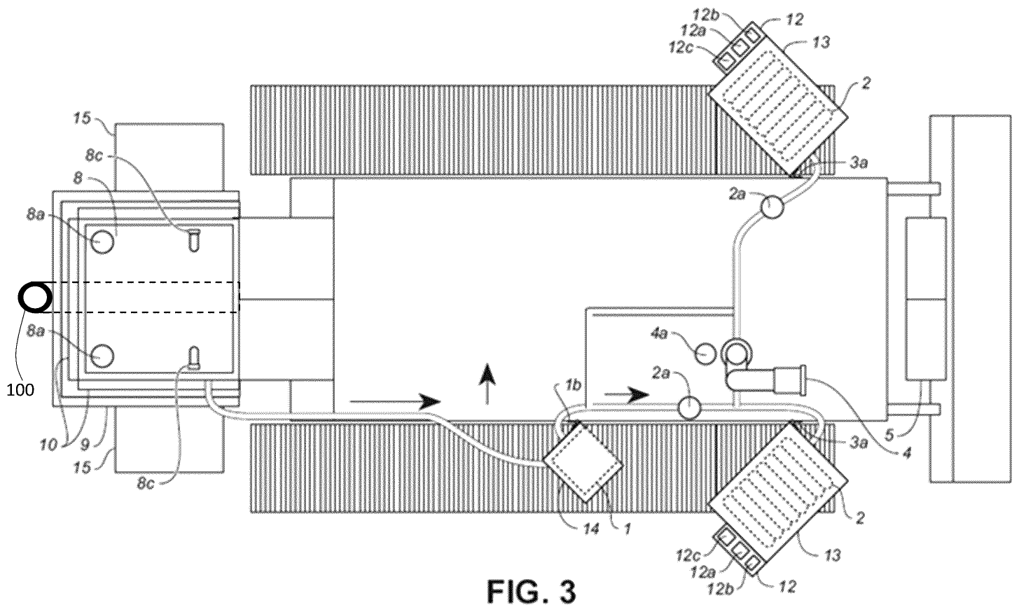

FIG. 3 shows the hose reels 2 in a protective hose reel cabinets 13 that are mounted on a hose reel platform 3, and a platform hinge 3a can couple the hose reel platform 3 to the dozer. The hose reel cabinets can swing out of the way to allow access to the engine compartment for maintenance and repairs.

The apparatus can further include a single monitor 4 that can be mounted on top of the engine hood forward of the Exhaust Stack. The monitor can be coupled to a control unit that can connect to different components of the dozer and the apparatus for receiving the input. The control unit can be remotely controlled. The control unit can be connected to the pump, water tank, and hose reels. The level of water in the water tank can be read by a sensor that provides the reading to the control unit, and the same can be displayed on the monitor. Similarly, the status and use of hose reels can be shown on the monitor. The monitor can be positioned in line with the exhaust stack so as not to compound and obstruct the operator's view.

The apparatus can further include Fire hose manifolds 12 with 1.5-inch fire hose outlet 12a and 1.0-inch fire hose outlets 12b, both with valves, and can be installed adjacent to the hose reels. The apparatus can further include sprinklers/nozzles that may be arranged in distinct positions of the dozer, such as to spray water on the ground (Fireline) around and nearby the dozer, such as the surroundings of the dozer. The nozzles can also spray water on the body of the dozer as a safeguard against fire damaging the dozer. The operation of these spray nozzles/sprinklers can be controlled by the control unit in the operator's cabin.

FIGS. 1 and 3 illustrate fire hose cabinets 5 mounted on the rear side of the dozer blade. These cabinets are configured to store fire hoses and may vary in design based on the construction of the dozer blade. For instance, in the case of a straight blade configuration (as shown in FIG. 1), a single fire hose cabinet may be provided. In configurations featuring a straight blade with swing capability, additional space may allow for multiple cabinets. An alternative fire hose cabinet 6 is also shown mounted below the operator canopy. The illustrated canopy includes a rollover protection structure, which is constructed from a rigid material to safeguard the operator in the event of a rollover or falling debris. Cabinet 6 is positioned beneath this canopy to provide additional storage for fire hoses or related equipment.

In addition to the main water tank, one or more auxiliary sub-tanks may be provided to increase overall water storage capacity. For example, sub-tanks can be positioned on the left and right sides of the main tank. Additional water tanks 104 (FIG. 1) and 108 (FIG. 2) may also be mounted at the rear of the blade, adjacent to or integrated with the fire hose cabinets 5. These supplementary tanks work in conjunction with the main rear tank to supply additional water. All tanks may be interconnected via a plumbing system, allowing for seamless integration and eliminating the need for manual switching between tanks. Additional tanks 110 in between track may also be includes for additional water capacity.

A hitch 100 may also be incorporated into the bulldozer, preferably mounted on the rear side. This hitch can be affixed to the rear of the chassis or the main tank. It is configured to enable the towing of the bulldozer, for instance, in the event of a mechanical failure. Additionally, the hitch facilitates the extraction of the bulldozer if it becomes immobilized while engaged in fire suppression or dozing operations.

While the foregoing written description enables a person of ordinary skill in the art to make and use what is presently considered to be the best mode of the invention, it will be understood and appreciated that various modifications, combinations, and equivalents of the specific embodiments, methods, and examples described herein are possible. Accordingly, the invention is not limited to the particular embodiments, methods, or examples disclosed, but encompasses all embodiments and methods that fall within the scope and spirit of the invention as defined by the appended claims.

What is claimed is:

1. An apparatus for a bulldozer, the bulldozer comprises a blade and a canopy, the apparatus comprises:
a frame configured to couple to a rear of the bulldozer;
a tank mounted to the frame, the tank configured to hold water, the tank comprises a plurality of baffles dispersed throughout an inner volume of the tank, the plurality of baffles are configured to prevent wobbling of the water inside the tank during movement of the bulldozer;
a water pump that has an input and an output, the input of the water pump is coupled to a bottom of the tank through a conduit to receive water from the tank, the output of the water pump is coupled to one or more hose reels; and
one or more fire hose cabinets mounted to a rear of the blade and/or to a bottom of the canopy.

2. The apparatus of claim 1, wherein the one or more fire hose cabinets are mounted to the rear of the blade.

3. The apparatus of claim 1, wherein the one or more fire hose cabinets are mounted to the canopy.

4. The apparatus of claim 1, wherein one or more fire hose cabinets are mounted to each of the rear of the blade and the canopy.

5. The apparatus of claim 1, wherein the apparatus further comprises auxiliary tanks mounted on left and right sides of the tank.

6. The apparatus of claim 5, wherein an additional tank is mounted to a rear of the blade, wherein the tank, the auxiliary tanks, and the additional tank are interconnected through a plumbing system.

7. The apparatus of claim 1, wherein the apparatus further comprises a hitch mounted to the tank and configured for towing the bulldozer.

8. The apparatus according to claim 1, wherein the apparatus further comprises:
two cabinets encasing two hose reels, wherein the two cabinets are mounted to two hose reel platforms respectively.

9. The apparatus according to claim 1, wherein the apparatus further comprises a plurality of sprinklers configured to mount at predefined positions on the bulldozer and sprinkle water from the tank in surroundings of the bulldozer.

10. The apparatus according to claim 9, wherein the apparatus further comprises a control unit, wherein the control unit is operably coupled to the plurality of sprinklers for remotely controlling operation of the plurality of sprinklers.

11. A bulldozer for controlling wildfires, the bulldozer comprises:
a bulldozer body;
a frame coupled to a rear of the dozer body;
a blade;
a canopy;
a tank mounted to the frame, the tank configured to hold water, the tank comprises a plurality of baffles dispersed throughout an inner volume of the tank, the plurality of baffles are configured to prevent wobbling of the water inside the tank during movement of the bulldozer;
a water pump that has an input and an output, the input of the water pump is coupled to a bottom of the tank through a conduit to receive water from the tank, the output of the water pump is coupled to one or more hose reels; and
one or more fire hose cabinets mounted to a rear of the blade and/or to a bottom of the canopy.

12. The bulldozer according to claim 11, wherein the one or more fire hose cabinets are mounted to the rear of the blade.

13. The bulldozer according to claim 11, wherein the one or more fire hose cabinets are mounted to the canopy.

14. The bulldozer according to claim 11, wherein the one or more fire hose cabinets are mounted to each of the rear of the blade and the canopy.

15. The bulldozer according to claim 11, wherein the bulldozer further comprises auxiliary tanks mounted on left and right sides of the tank.

16. The bulldozer according to claim 11, wherein an additional tank is mounted to a rear of the blade, wherein the tank, the auxiliary tanks, and the additional tank are interconnected through a plumbing system.

17. The bulldozer according to claim 11, wherein the bulldozer further comprises a hitch mounted to the tank and configured for towing the bulldozer.

18. The bulldozer according to claim 11, wherein the bulldozer further comprises:
two cabinets encasing two hose reels, wherein the two cabinets are mounted to two hose reel platforms respectively.

19. The bulldozer according to claim 11, wherein the bulldozer further comprises a plurality of sprinklers configured to mount at predefined positions on the bulldozer and sprinkle water from the tank in surroundings of the bulldozer.

20. The bulldozer according to claim 19, wherein the bulldozer further comprises a control unit, wherein the control unit is operably coupled to the plurality of sprinklers for remotely controlling operation of the plurality of sprinklers.
